(19) United States
(12) Patent Application Publication
(10) Pub. No.: US 2012/0051433 A1
(43) Pub. Date: Mar. 1, 2012

(54) VIDEO PROCESSING DEVICE AND VIDEO PROCESSING METHOD

(75) Inventors: Mikiko Roji, Hyogo (JP); Masayasu Iguchi, Hyogo (JP); Kotaro Esaki, Osaka (JP); Hiroshi Amano, Osaka (JP)

(73) Assignee: Panasonic Corporation, Osaka (JP)

(21) Appl. No.: 13/292,543

(22) Filed: Nov. 9, 2011

Related U.S. Application Data
(63) Continuation of application No. PCT/JP2009/005926, filed on Nov. 6, 2009.

(30) Foreign Application Priority Data
May 26, 2009 (JP) 2009-126905

(51) Int. Cl. H04N 7/32

(52) U.S. Cl. 375/240.16; 375/E07.256

(57) ABSTRACT

While temporal and spatial direct modes are both supported, the amount of temporarily-stored direct-mode prediction information is reduced, thereby reducing the memory bus bandwidth. A motion information generator combines a motion vector for an anchor block with the number of a reference picture of the anchor block, thereby generates motion information of the pixel block. A still-state determination unit determines whether or not the pixel block is considered still based on the motion vector for the anchor block and on the number of the reference picture. A selector selectively stores in a memory either an output of the motion information generator or a determination result of the still-state determination unit as direct-mode prediction information of the pixel block. A motion vector predictor predicts a motion vector for the pixel block in direct mode based on the direct-mode prediction information stored in the memory.

### CROSS-REFERENCE TO RELATED APPLICATION

This is a continuation of PCT International Application PCT/JP2009/005926 filed on Nov. 6, 2009, which claims priority to Japanese Patent Application No. 2009-126905 filed on May 26, 2009. The disclosures of these applications including the specifications, the drawings, and the claims are hereby incorporated by reference in its entirety.

### BACKGROUND

The present disclosure relates to video stream processing devices, and more particularly to video processing devices and video processing methods for predicting motion vectors for image blocks in direct mode.

Video compression encoding standards, such as H.264/AVC, define direct mode for predicting and generating a motion vector for a pixel block from a motion vector for a pixel block which has already been encoded. Usage of direct mode eliminates the need to encode a motion vector difference of a target pixel block to be encoded, thereby allowing the video compression efficiency to be improved.

Direct mode has two types: temporal direct mode and spatial direct mode. In temporal direct mode, the reference picture of an anchor block is the reference picture of the target pixel block in the L0 direction, using as the anchor picture the picture having the lowest reference number in the L1 direction of the target picture to which the target pixel block belongs, and using as the anchor block the pixel block at a same spatial location as the target pixel block in the anchor picture. Motion vectors for the target pixel block in the L0 and L1 directions are obtained by proportionally dividing the motion vector for the anchor block respectively among time intervals of the target picture and the reference picture and among time intervals of the target picture and the anchor picture.

Meanwhile, spatial direct mode considers the target pixel block to be still (colZeroFlag=1), and thus the motion vector therefor to be zero if the motion vector for the anchor block and the reference picture thereof satisfy all the conditions described below.

1. The horizontal and vertical magnitudes of the motion vector for the anchor block are both less than or equal to ±1.

2. The reference number of the reference picture of the anchor block is 0.

3. The picture having the lowest reference number in the L0 direction is a short-term reference picture.

Meanwhile, if at least one of the above conditions is not satisfied, the motion vectors for the target pixel block in the L0 and L1 directions are calculated from the motion vectors of the left, upper, and upper-right adjacent blocks of the target pixel block (more precisely, a macroblock having a predetermined size including the target pixel block) in the target picture (see, e.g., Japanese Patent Publication No. 2005-244503).

If a motion vector is predicted in temporal direct mode, the motion vector for the anchor block and the number of the reference picture need to be temporarily stored in a memory for every target pixel block in addition to information of the target picture. Meanwhile, if a motion vector is predicted in spatial direct mode, only the flag colZeroFlag needs to be temporarily stored in a memory for every target pixel block in addition to information of the target picture, thereby allowing the amount of use and bandwidth of the memory to be reduced to about one thirtieth. In particular, when, for example, video having an aspect ratio of high-definition television (HDTV) is processed, the difference is significant.

A conventional video processing device temporarily stores the motion vector for the anchor block and the number of the reference picture in a memory as direct-mode prediction information of the target pixel block so as to support both temporal and spatial direct modes, or if the device is an encoder, only the flag colZeroFlag is temporarily stored in the memory as direct-mode prediction information, thereby limiting the available mode to spatial direct mode. The former case requires not only a large memory capacity for temporarily storing the direct-mode prediction information, but also a relatively broad memory bus bandwidth for transferring the direct-mode prediction information, thereby increasing the cost. Meanwhile, the latter case allows the cost to be reduced due to a lower data transfer rate since the amount of direct-mode prediction information temporarily stored in the memory is lower; however, since only spatial direct mode can be used, image quality may deteriorate. Moreover, the latter technique cannot be applied to decoders.

### SUMMARY

The present invention is advantageous in that while temporal and spatial direct modes are both supported, the amount of temporarily-stored direct-mode prediction information is reduced, thereby reducing the memory bus bandwidth.

For example, a video processing device and a video processing method respectively include a motion information generator configured to combine a motion vector for an anchor block at a different temporal location from, and at a same spatial location as, a pixel block for which a motion vector should be predicted in direct mode, with a number of a reference picture of the anchor block, thereby generate motion information of the pixel block, and a step corresponding thereto, a still-state determination unit configured to determine whether or not the pixel block is considered still based on the motion vector for the anchor block and on the number of the reference picture, and a step corresponding thereto, a selector configured to selectively store in a memory either an output of the motion information generator or a determination result of the still-state determination unit as direct-mode prediction information of the pixel block, and a step corresponding thereto, and a motion vector predictor configured to predict a motion vector for the pixel block in direct mode based on the direct-mode prediction information stored in the memory, and a step corresponding thereto.

According to this, either the motion information including a large amount of information or the result of still-state determination including a small amount of information are selectively stored in a memory. Accordingly, a motion vector can be predicted in temporal direct mode when the motion information is stored, while only spatial direct mode is used when the result of still-state determination is stored, thereby allowing both the amount of memory used and the memory bus bandwidth to be reduced.

Preferably, the video processing device includes a data detector configured to instruct the selector to select the determination result of the still-state determination unit when predetermined data is detected in an input video stream. More preferably, the data detector instructs the selector to select the output of the motion information generator until the predetermined data is detected.

According to this, it is determined that a video stream in which predetermined data is inserted is processible using spatial direct mode only, and thus the result of still-state determination is stored in the memory as the direct-mode prediction information, thereby allowing the memory bus bandwidth to be reduced.

Preferably, the video processing device includes a data transfer bandwidth measurement unit configured to measure a data transfer bandwidth of the memory, and to instruct the selector to select the output of the motion information generator if the data transfer bandwidth is less than a threshold, and to instruct the selector to select the determination result of the still-state determination unit if the data transfer bandwidth is greater than the threshold.

According to this, temporal and spatial direct modes can be both supported if the memory bus bandwidth is sufficient, while when the memory bus bandwidth is likely to fall short, the mode used is switched to spatial direct mode, which requires a smaller amount of direct-mode prediction information to be temporarily stored in the memory, thereby allowing the memory bus bandwidth to be reduced.

Preferably, the video processing device includes a decoder configured to decode an input video stream, and an error detector configured to detect an error if the determination result of the still-state determination unit is stored in the memory as direct-mode prediction information of a pixel block for which a motion vector should be predicted in temporal direct mode. The decoder performs an error concealment process when the error is detected. More specifically, the decoder skips decoding of a picture including a pixel block relating to the error detection, and outputs another picture which has already been decoded, or decodes the picture including the pixel block relating to the error detection using spatial direct mode instead, as the error concealment process.

According to this, even if poor direct-mode prediction information prevents a motion vector from being predicted in temporal direct mode, the decoding process of the video stream can be continued without stopping.

Preferably, the video processing device includes an encoder configured to generate a video stream, and a direct mode specifier configured to specify either temporal or spatial direct mode to the selector, to the motion vector predictor, and to the encoder, where if spatial direct mode is specified, the selector selects the determination result of the still-state determination unit, and if spatial direct mode is specified, the encoder inserts, in the video stream, predetermined data indicating that the video stream can be decoded in spatial direct mode.

According to this, when a video stream is generated, the amount of the direct-mode prediction information to be temporarily stored for use in direct mode can be reduced, thereby allowing the memory bus bandwidth to be reduced.

### BRIEF DESCRIPTION OF THE DRAWINGS

FIG. 1 is a configuration diagram of a main part of a video processing device according to the first embodiment.

FIG. 2 is a flowchart of a video decoding process performed by the video processing device according to the first embodiment.

FIG. 3 is a configuration diagram of a main part of a video processing device according to the second embodiment.

FIG. 4 is a configuration diagram of a main part of a video processing device according to the third embodiment.

FIG. 5 is a configuration diagram of a main part of a video processing device according to the fourth embodiment.

FIG. 6 is a schematic diagram of a video processing device according to the fifth embodiment.

### DETAILED DESCRIPTION

Example embodiments of the present invention will be described below with reference to the drawings. Although the example embodiments below are described as complying with the H.264/AVC standard for purposes of illustration, it is understood that the present invention is not limited thereto.

### First Embodiment

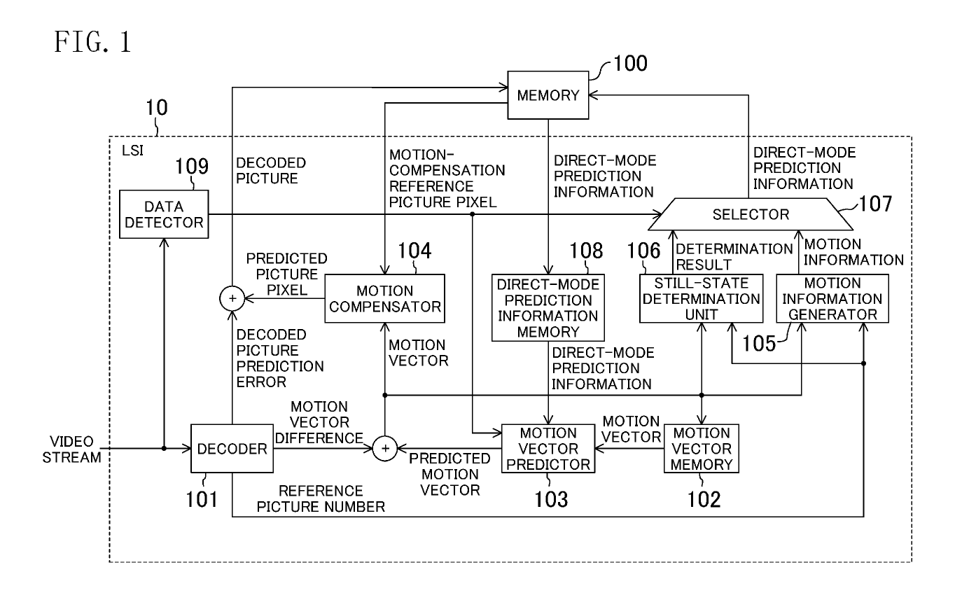

FIG. 1 illustrates a configuration of a main part of a video processing device according to the first embodiment. More specifically, the video processing device according to this embodiment is a video decoder for decoding an input video stream. The main part of the video decoder according to this embodiment can be integrated as an LSI 10. A decoder 101 outputs a decoded picture prediction error, a motion vector difference, and a reference picture number from the input video stream. The motion vector difference is added to a predicted motion vector output from a motion vector predictor 103, and thus a motion vector is generated. The motion vector is stored in a motion vector memory 102. The motion vector predictor 103 reads the motion vector from the motion vector memory 102 as appropriate, and generates the predicted motion vector. A motion compensator 104 generates a predicted picture pixel from both the motion vector and a motion-compensation reference picture pixel read from a memory 100. The predicted picture pixel is added to the decoded picture prediction error output from the decoder 101, thereby generating a decoded picture, which is then stored in the memory 100.

A motion information generator 105 receives a motion vector for an anchor block which is referred to upon a direct mode prediction and a reference picture number, and combines the motion vector and the reference picture number, thereby generates motion information of a target pixel block. Meanwhile, a still-state determination unit 106 also receives the motion vector for the anchor block and the reference picture number, and determines whether or not the target pixel block can be considered still. The determining conditions used are as described above. A selector 107 selectively stores in the memory 100 either an output of the motion information generator 105 or a determination result of the still-state determination unit 106 as direct-mode prediction information of the target pixel block. As the determination result of the still-state determination unit 106, for example, a flag colZeroFlag can be used.

Upon a direct mode prediction, the motion vector predictor 103 generates a direct-mode motion vector as the predicted motion vector, referring to the direct-mode prediction information read from the memory 100 to a direct-mode prediction information memory 108, based on the output of a data detector 109.

The selection operation of the selector 107 is controlled by the data detector 109. The data detector 109 instructs the selector 107 to select the determination result of the still-state determination unit 106 when predetermined data is detected in the video stream input to the video decoder. The data detector 109 instructs the selector 107 to select the output of the motion information generator 105 until the predetermined data is detected. The predetermined data is information indicating whether a motion vector can be predicted or not in spatial direct mode. The predetermined data is, for example, included in the video stream as supplemental enhancement information (SEI) in the video stream, or included in one of the header of a packetized elementary stream (PES), the header of a picture, or the header of a slice. Alternatively, direct_spatial_mv_pred_flag included in the header of a slice can be used as the predetermined data.

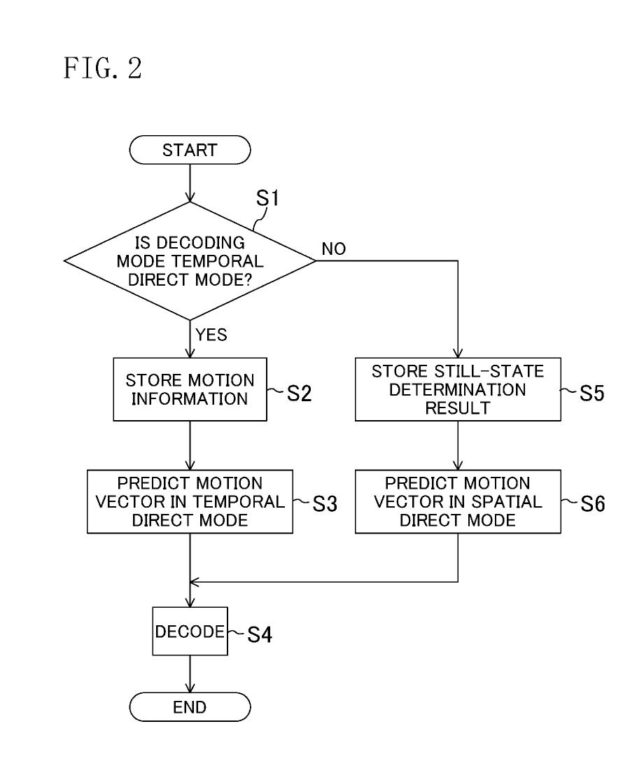

FIG. 2 illustrates a flow of a video decoding process performed by the video processing device according to this embodiment. First, it is determined whether decoding mode is temporal direct mode or spatial direct mode (S1). If the mode is temporal direct mode, motion information generated by the motion information generator 105 is stored in the memory 100 (S2), and a motion vector is predicted in temporal direct mode, and then the video is decoded (S3, S4). Meanwhile, if the mode is spatial direct mode, the determination result of the still-state determination unit 106 is stored in the memory 100 (S5), and a motion vector is predicted in spatial direct mode, and then the video is decoded (S6, S4).

Thus, according to this embodiment, if it is indicated in the input video stream that the video stream can be decoded only using spatial direct mode, then the amount of the direct-mode prediction information temporarily stored for use in direct mode can be reduced, thereby allowing the memory bus bandwidth to be reduced. Note that such a video stream is generated by a video encoder described later.

### Second Embodiment

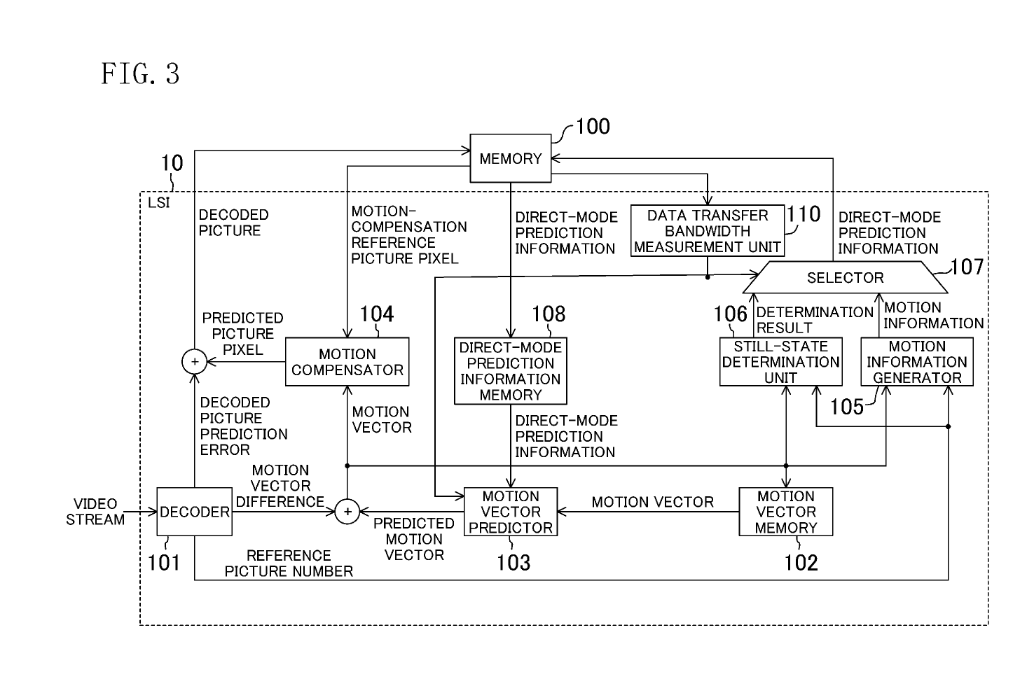

FIG. 3 illustrates a configuration of a main part of a video processing device according to the second embodiment. The video processing device according to this embodiment is also a video decoder, and includes a data transfer bandwidth measurement unit 110 instead of the data detector 109 in the video processing device of FIG. 1. The data transfer bandwidth measurement unit 110 measures the data transfer bandwidth of the memory 100, and instructs the selector 107 to select the output of the motion information generator 105 if the data transfer bandwidth is less than a threshold. Meanwhile, if the data transfer bandwidth is greater than the threshold, the data transfer bandwidth measurement unit 110 instructs the selector 107 to select the determination result of the still-state determination unit 106.

Thus, this embodiment allows a motion vector to be predicted in an appropriate one of either temporal or spatial direct mode if the memory bus bandwidth is sufficient, thereby allowing the quality of decoded images to be kept high, while when the memory bus bandwidth is likely to fall short, this embodiment allows a motion vector to be predicted in spatial direct mode, which requires a smaller amount of direct-mode prediction information to be temporarily stored, thereby allowing the memory bus bandwidth to be reduced, and a failure of decoding process to be prevented.

Instead of providing the data transfer bandwidth measurement unit 110 in the LSI 10, the data transfer bandwidth may be measured in the memory 100.

### Third Embodiment

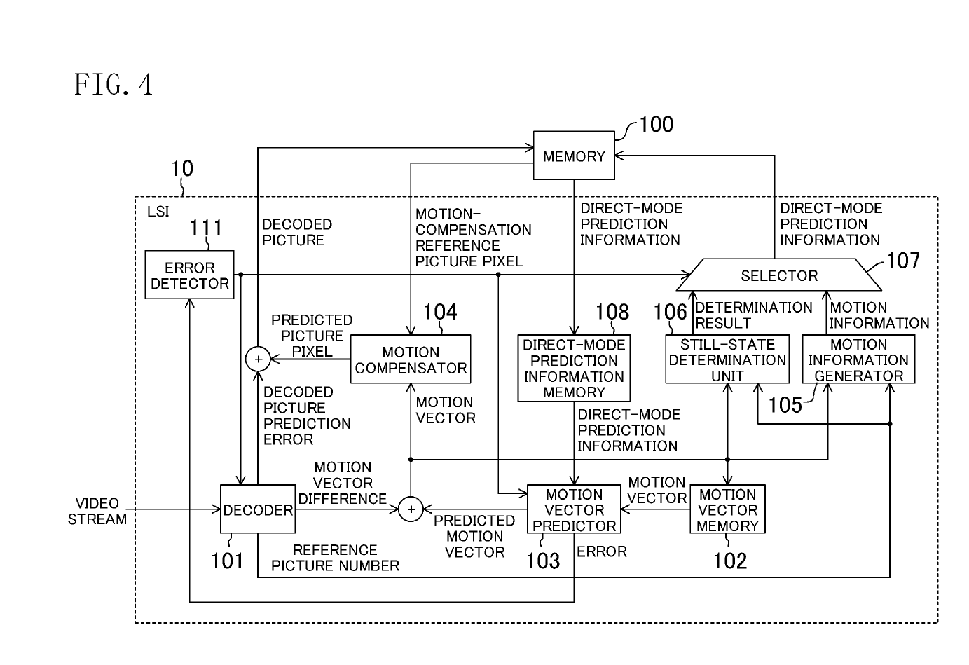

FIG. 4 illustrates a configuration of a main part of a video processing device according to the third embodiment. The video processing device according to this embodiment is also a video decoder, and includes an error detector 111 in place of the data detector 109 in the video processing device of FIG. 1. The error detector 111 detects an error when the determination result of the still-state determination unit 106 is stored in the memory 100 as the direct-mode prediction information of the pixel block for which a motion vector should be predicted in temporal direct mode, thereby preventing the motion vector from being correctly predicted, and instructs the selector 107 to select the output of the motion information generator 105. Then, until the input video stream can be decoded in temporal direct mode, the error detector 111 instructs the motion vector predictor 103 and the decoder 101, for example, to skip decoding of a picture including that pixel block, and to use a picture which has already been decoded instead of that picture, or to decode the picture in spatial direct mode instead. Thus, the decoding process of the video stream can be continued without stopping.

### Fourth Embodiment

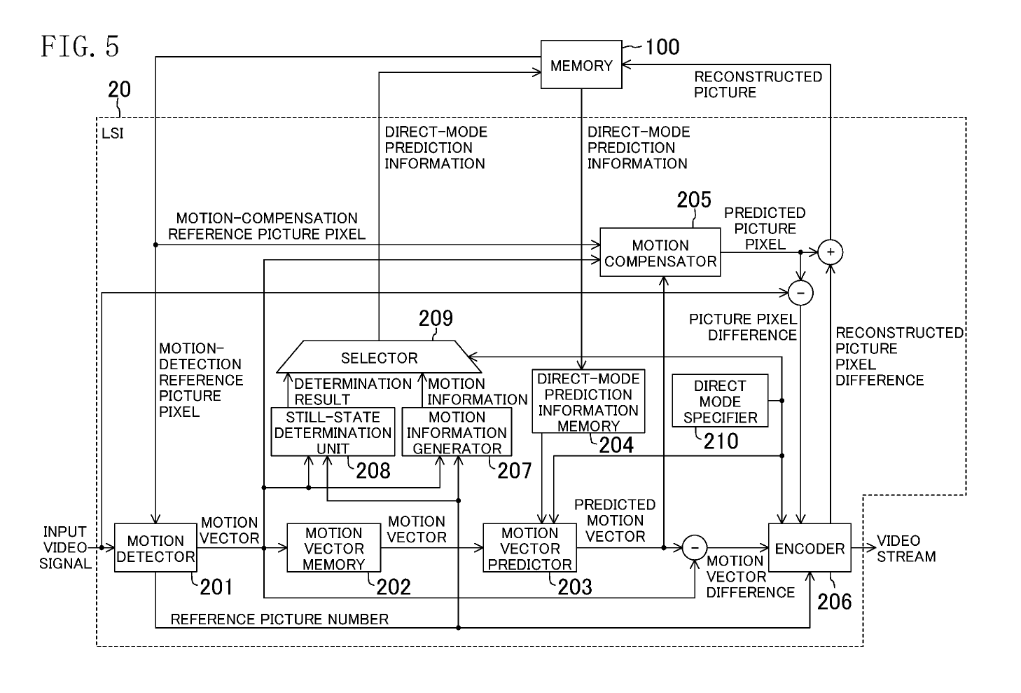

FIG. 5 illustrates a configuration of a main part of a video processing device according to the fourth embodiment. More specifically, the video processing device according to this embodiment is a video encoder for encoding an input video signal. The main part of the video encoder according to this embodiment can be integrated as an LSI 20. A motion detector 201 compares an input video signal with a motion-detection reference picture pixel read from the memory 100 external to the LSI 20, and outputs a motion vector and a reference picture number. The motion vector is stored in a motion vector memory 202. A motion vector predictor 203 reads a motion vector for a pixel block near a target pixel block from the motion vector memory 202, and generates a predicted motion vector. In addition, upon a direct mode prediction, the motion vector predictor 203 generates a direct-mode motion vector as a predicted motion vector, referring to direct-mode prediction information read from the memory 100 to a direct-mode prediction information memory 204. A motion compensator 205 generates a predicted picture pixel from the motion vector, from the predicted motion vector, and from the motion-compensation reference picture pixel.

An encoder 206 encodes a picture pixel difference, which is a difference between the input video signal and a predicted picture pixel, based on a motion vector difference, which is a difference between a motion vector and the predicted motion vector, and on the reference picture number, and then decodes the result, thereby generates a reconstructed picture pixel difference. Eventually, the encoder 206 generates a video stream. The reconstructed picture pixel difference is added to the predicted picture pixel, thereby generating a reconstructed picture, which is then stored in the memory 100. The reconstructed picture stored in the memory 100 is used as a motion-detection reference picture and a motion-compensation reference picture.

A motion information generator 207 receives a motion vector for an anchor block which is referred to upon a direct mode prediction and a reference picture number, and combines the motion vector and the reference picture number, thereby generates motion information of a target pixel block. Meanwhile, a still-state determination unit 208 also receives the motion vector for the anchor block and the reference picture number, and determines whether or not the target pixel block can be considered still. The determining conditions used are as described above. A selector 209 selectively stores in the memory 100 either an output of the motion information generator 207 or a determination result of the still-state determination unit 208 as direct-mode prediction information of the target pixel block. As the determination result of the still-state determination unit 208, for example, a flag colZeroFlag can be used.

A direct mode specifier 210 specifies either temporal or spatial direct mode to the selector 209, to the motion vector predictor 203, and to the encoder 206. For example, if the direct mode specifier 210 specifies spatial direct mode, the selector 209 selects the output of the still-state determination unit 208, and the motion vector predictor 203 predicts the motion vector for the target pixel block in spatial direct mode. Moreover, if the direct mode specifier 210 specifies spatial direct mode, the encoder 206 inserts, in the video stream to be generated, predetermined data indicating that the video stream can be decoded in spatial direct mode. For example, the predetermined data can be inserted in the video stream as SEI, or inserted in the header of one of a PES, a picture, or a slice. Alternatively, direct_spatial_mv_pred_flag included in the header of a slice can be used as the predetermined data.

Thus, according to this embodiment, when a video stream is generated, the amount of the direct-mode prediction information to be temporarily stored for use in direct mode can be reduced, thereby allowing the memory bus bandwidth to be reduced. Moreover, a video stream in which predetermined data has been inserted can be generated for a particular video decoder such as one described in the first embodiment.

Note that the data transfer bandwidth measurement unit 110 in FIG. 3 may be added as a variation of this embodiment. In this case, if the memory bus bandwidth is sufficient, the entire information for direct mode prediction is temporarily stored, and an appropriate one of either temporal or spatial direct mode is specified, and when the memory bus bandwidth is likely to fall short, a motion vector is predicted in spatial direct mode, which requires a smaller amount of direct-mode prediction information to be temporarily stored, thereby allowing the memory bus bandwidth to be reduced, and a failure of encoding process to be prevented. When the memory bus bandwidth changes the status from an insufficient state to a sufficient state, the direct-mode prediction information to be temporarily stored is changed to the entire information accordingly; however, the encoding process is performed in spatial direct mode until encoding in temporal direct mode becomes possible.

### Fifth Embodiment

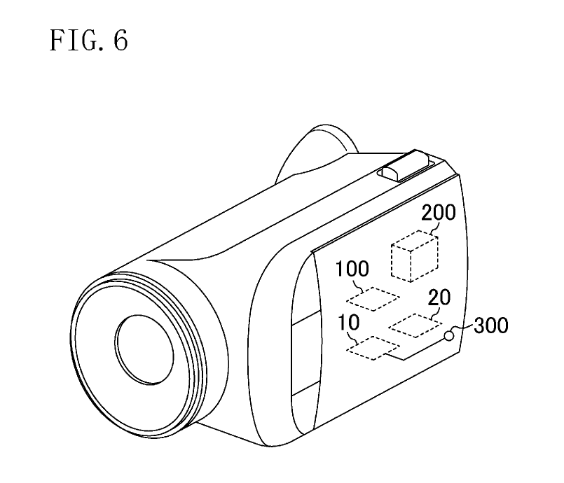

FIG. 6 illustrates an overview of a video processing device according to the fifth embodiment. More specifically, the video processing device according to this embodiment is a video camera. The video camera includes the aforementioned LSI 20 as a video encoder, the aforementioned LSI 10 as a video decoder, the memory 100 for temporarily storing data, and a storage device 200 for storing streaming data. Video data input to the video camera is encoded by the LSI 20, and is stored in the storage device 200. Meanwhile, the streaming data read from the storage device 200 is decoded by the LSI 10, and is stored in the memory 100. The video data stored in the memory 100 is output to the outside world through a video output 300. Commonly-used video cameras often do not include high speed, high capacity memories for cost reduction. Thus, including the video encoder and the video decoder described above allows even a video camera having a relatively low-priced memory to perform recording and reproduction at high image quality using temporal direct mode if the memory bus bandwidth is sufficient, and when the memory bus bandwidth is likely to fall short, the mode is changed to spatial direct mode, and thus a failure of recording and/or reproduction processes can prevented.

Each function block, the LSI 10, and LSI 20 shown in FIGS. 1 and 3-5 are typically implemented in the form of an LSI, which is an integrated circuit. The function blocks and the LSIs may each be individually implemented in one chip, or a part or all of the function blocks and the LSIs may be implemented in one chip. The memory 100 etc. has a large capacity, and thus may be implemented in a large capacity SDRAM external to an LSI, or may be implemented in one package or in one chip.

Although the term “LSI” has been used herein, other terms such as IC, system LSI, super LSI, or ultra LSI may be used depending on the integration level. The technique for implementing an integrated circuit is not limited to an LSI, but an integrated circuit may be implemented in a dedicated circuit or a general-purpose processor. A field programmable gate array (FPGA), which is programmable after the LSI fabrication, or a reconfigurable processor in which connections and settings of circuit cells can be dynamically reconfigured in the LSI, may be used. Moreover, if a technology of implementing an integrated circuit which supersedes the LSI is achieved due to a progress of semiconductor technology or another technology derived therefrom, function blocks may, of course, be integrated using such a technology. Application of biotechnology etc. may also be one possibility.

What is claimed is:

1. A video processing device, comprising:
a motion information generator configured to combine a motion vector for an anchor block at a different temporal location from, and at a same spatial location as, a pixel block for which a motion vector should be predicted in direct mode, with a number of a reference picture of the anchor block, thereby generate motion information of the pixel block;
a still-state determination unit configured to determine whether or not the pixel block is considered still based on the motion vector for the anchor block and on the number of the reference picture;
a selector configured to selectively store in a memory either an output of the motion information generator or a determination result of the still-state determination unit as direct-mode prediction information of the pixel block; and
a motion vector predictor configured to predict a motion vector for the pixel block in direct mode based on the direct-mode prediction information stored in the memory.

2. The video processing device of claim 1, comprising:
a data detector configured to instruct the selector to select the determination result of the still-state determination unit when predetermined data is detected in an input video stream.

3. The video processing device of claim 2, wherein
the data detector instructs the selector to select the output of the motion information generator until the predetermined data is detected.

4. The video processing device of claim 1, comprising:
a data transfer bandwidth measurement unit configured to measure a data transfer bandwidth of the memory, and to instruct the selector to select the output of the motion information generator if the data transfer bandwidth is less than a threshold, and to instruct the selector to select the determination result of the still-state determination unit if the data transfer bandwidth is greater than the threshold.

5. The video processing device of claim 1, comprising:
a decoder configured to decode an input video stream; and
an error detector configured to detect an error if the determination result of the still-state determination unit is stored in the memory as direct-mode prediction information of a pixel block for which a motion vector should be predicted in temporal direct mode, wherein
the decoder performs an error concealment process when the error is detected.

6. The video processing device of claim 5, wherein
the decoder skips decoding of a picture including a pixel block relating to the error detection, and outputs another picture which has already been decoded, or decodes the picture including the pixel block relating to the error detection using spatial direct mode instead, as the error concealment process.

7. The video processing device of claim 1, comprising:
an encoder configured to generate a video stream; and
a direct mode specifier configured to specify either temporal or spatial direct mode to the selector, to the motion vector predictor, and to the encoder,
wherein
if spatial direct mode is specified, the selector selects the determination result of the still-state determination unit, and
if spatial direct mode is specified, the encoder inserts, in the video stream, predetermined data indicating that the video stream can be decoded in spatial direct mode.

8. The video processing device of claim 2, wherein
the predetermined data is included in the video stream as additional information.

9. The video processing device of claim 7, wherein
the predetermined data is included in the video stream as additional information.

10. The video processing device of claim 8, wherein
the predetermined data is included in the video stream as supplemental enhancement information (SEI).

11. The video processing device of claim 9, wherein
the predetermined data is included in the video stream as supplemental enhancement information (SEI).

12. The video processing device of claim 8, wherein
the predetermined data is included in one of a header of a packetized elementary stream (PES) in the video stream, a header of a picture, or a header of a slice.

13. The video processing device of claim 9, wherein
the predetermined data is included in one of a header of a packetized elementary stream (PES) in the video stream, a header of a picture, or a header of a slice.

14. The video processing device of claim 2, wherein
the predetermined data is a direct prediction flag of each slice.

15. The video processing device of claim 7, wherein
the predetermined data is a direct prediction flag of each slice.

16. The video processing device of claim 14, wherein
the predetermined data is direct_spatial_mv_pred_flag included in a header of a slice.

17. The video processing device of claim 15, wherein
the predetermined data is direct_spatial_mv_pred_flag included in a header of a slice.

18. The video processing device of claim 1, wherein
the still-state determination unit outputs one bit of determination result.

19. A video processing method, comprising:
combining a motion vector for an anchor block at a different temporal location from, and at a same spatial location as, a pixel block for which a motion vector should be predicted in direct mode, with a number of a reference picture of the anchor block, thereby generating motion information of the pixel block;
determining whether or not the pixel block is considered still based on the motion vector for the anchor block and on the number of the reference picture;
selectively storing in a memory either the motion information or a result of the determining as direct-mode prediction information of the pixel block; and
predicting a motion vector for the pixel block in direct mode based on the direct-mode prediction information stored in the memory.
